(19) United States
(12) Patent Application Publication
(10) Pub. No.: US 2010/0201529 A1
(43) Pub. Date: Aug. 12, 2010

(54) METHOD OF FACILITATING ACCESS TO OPERATOR FUNCTIONS OF HAZARDOUS CONDITION ALARM

(76) Inventor: Gilbert Alain Lindsay Garrick, Australian Capital Territory (AU)

Correspondence Address: JAMES SONNTAG;JAMES SONNTAG, PATENT ATTORNEY, P.O. BOX 9194, SALT LAKE CITY, UT, 84109, US

(21) Appl. No.: 11/996,164

(22) PCT Filed: Jun. 30, 2006
(86) PCT No.: PCT/AU2006/000906

§ 371 Date: Jan. 18, 2008

(30) Foreign Application Priority Data
Jul. 18, 2005 (AU) 2005903774

(51) Int. Cl. G08B 17/10

(52) U.S. Cl. 340/628

(57) ABSTRACT

A method of facilitating access by an operator for the purpose of carrying out one or more operator functions of a hazardous condition alarm device mounted on or near the ceiling, the method including: lowering the height above the floor at which the operator functions can be carried out.

### CROSS REFERENCE TO RELATED APPLICATIONS

Priority is claimed from PCT International Patent Application PCT/AU2006/00906, international filing date 3 Jun. 2006, which claims priority from Australian Application 2005903774, filed 18 Jul. 2005, both of which are hereby incorporated by reference.

### INTRODUCTION

This invention relates to hazardous condition alarm devices mounted on or near the ceiling as used in buildings, caravans, motor homes and boats to provide a warning when a hazardous condition such as that associated with the presence of fire, poisonous gas or combustible gas is detected, and to a method of facilitating access to operator functions of these alarm devices.

A number of terms and expressions are used herein and their meanings in relation to hazardous condition alarm devices of this invention are given below.

Alarm device: a hazardous condition alarm device.

Alarm device silencing facility: the silencing facility of a hazardous condition alarm device is useful for deactivating the audible and/or visual warning provided by the alarm device when a hazardous condition is detected or in the event of a false or nuisance alarm. The silencing function of a hazardous condition alarm device is usually activated by operating a momentary action normally open alarm device silence switch.

Alarm device test facility: the test facility of a hazardous condition alarm device allows the manual testing of the detector and warning functions of the alarm device. The test function of a hazardous condition alarm device is usually activated by operating a momentary action normally open alarm device test switch.

Alarm mode: condition of an alarm device when a hazardous condition has been detected. The alarm mode is characterised by the emission of a warning, audible and/or visual, to alert occupants of the hazardous condition.

Dual supply alarm device: a hazardous condition alarm device operating from two power sources, namely a primary power supply such as mains electricity supply and a standby battery power supply for powering the alarm device when the primary power supply is not available or has failed. Dual supply alarm devices are generally more reliable when compared to single supply alarm devices since the loss of one power supply, for example mains primary power supply as a result of an electrical fault, does not result in the hazardous condition alarm device becoming inoperative. However, dual supply alarm devices are generally more expensive when compared to single supply alarm devices.

Facilitate: make easier or less difficult.

Extension: in relation to a hazardous condition alarm device of this invention, the word extension is to be taken to mean an increase in the physical dimensions of the hazardous condition alarm device such as an increase in length or height of the device.

Hazardous condition: the presence of smoke, heat, carbon monoxide, poisonous gas or combustible gas.

Hazardous condition alarm device: a smoke, heat, carbon monoxide, poisonous or combustible gas detector incorporating an audible and/or visual device to warn occupants when a hazardous condition is detected.

Hazardous condition alarm system: a system comprising of one or more hazardous condition alarm devices, a common single power supply source or a common dual power supply source, and a common control panel/box.

Low battery alarm: a brief warning, usually in the form of a single chirp, emitted to warn of a low battery condition when the battery of a hazardous condition alarm device is automatically tested in self-test mode.

Low battery pre-alarm: a brief warning, usually in the form of a single chirp, emitted to warn of an impending low battery condition when the battery of a hazardous condition alarm device is automatically tested in self-test mode. The low battery pre-alarm warning is provided when the battery of a hazardous condition alarm device has depleted to a level that is close, but slightly higher than that required to generate a low battery alarm.

The low battery pre-alarm facility of hazardous condition alarm devices is operable in an active mode in which the low battery pre-alarm warning is emitted when the required level of battery depletion is reached, and a bypass mode in which the low battery pre-alarm facility is deactivated and any low battery pre-alarm warning is silenced. The two modes of operation of the low battery pre-alarm facility are selectable by operating a two position active/bypass switch.

Operator: person carrying out the operator functions of a hazardous condition alarm device. The operator is usually a building occupant.

Operator function: a function carried out by building occupants and operators including testing the functionality of a hazardous condition alarm device, silencing the warning provided by an alarm device when a hazardous condition is detected or when there is a false or nuisance alarm, bypassing the low battery pre-alarm facility of a hazardous condition alarm device when a warning of an impending low battery condition is provided, or replacing and installing the battery of a hazardous condition alarm device when a low battery condition exists and a low battery alarm is provided.

Operator function switch: a switch used for the purpose of carrying out an operator function of a hazardous condition alarm device.

Pendant: hanging or suspended.

Primary power supply: power supply supplying power to a hazardous condition alarm device at all times except during periods when the primary power supply is not available or has failed.

Quiescent mode: normal silent operating condition of a hazardous condition alarm device when the alarm device is not in alarm mode or self-test mode.

Self-test mode: brief and periodic automatic testing of the battery of a hazardous condition alarm device to determine its condition. In this mode, and if the battery is found to be low or defective, a brief warning, usually in the form of a single chirp, is emitted to warn of the low or defective battery condition.

Single supply alarm device: a hazardous condition alarm device operating from only one power source such as a battery power source or mains electricity power supply. Single supply alarm devices are less expensive when compared to dual supply alarm devices. Furthermore, battery operated single supply alarm devices such as battery operated smoke alarms are generally of very low cost.

Smoke alarm: a hazardous condition alarm device that is responsive to the presence of smoke.

Standby battery power supply: battery power supply supplying power to a hazardous condition alarm device only when the primary power supply is not available or has failed.

### BACKGROUND

A Hazardous condition alarm devices are used extensively in boats, caravans, motor homes, dwellings, motels, hotels, hostels, hospitals, old people's homes and other commercial premises to detect hazardous conditions such as a fire or the presence of poisonous or combustible gases, and to warn occupants when a hazardous condition is detected. With many types of hazardous condition alarm devices, for example alarm devices responsive to natural gas, carbon monoxide, heat and smoke, it is essential to locate the alarm devices on or near the ceiling to ensure the fastest response when a hazardous condition exists. For this reason, manufacturers of hazardous condition alarm devices responsive to natural gas, carbon monoxide, heat and smoke recommend that these alarm devices are installed on or near the ceiling generally in accordance with FIG. 1. Thus, according to the same manufacturers recommendations, particular care is required during alarm device installation so as not to locate the alarm devices on the ceiling any closer than 100 mm from the wall and ceiling joint, in the dead air corner space extending 100 mm vertically and horizontally from the wall and ceiling joint where natural gas, carbon monoxide, smoke or heat may not reach, or on the wall any lower than 300 mm below the wall and ceiling joint.

Because hazardous condition alarm devices are important life safety devices, they usually have provisions for enabling one or more operator functions to be carried out so as to ensure that the alarm devices continue to operate reliably over their design life, to minimise the inconvenience to occupants of false or nuisance alarms or to enhance the use and performance of the alarm devices. The importance and usefulness of the operator functions of hazardous condition alarm devices are as follows:

### Battery Replacement and Installation

The brief low battery alarm warning, emitted by a hazardous condition alarm device to warn of a low battery condition when the battery is automatically tested in self-test mode, serves as a prompt for occupants to replace the battery of the alarm device. Irrespective of whether the hazardous condition alarm device operates from a single battery supply or a dual power supply that includes a standby battery, timely replacement of the battery of the hazardous condition alarm device by occupants when a low battery alarm is provided is essential to ensure that the reliability of the alarm device is not compromised and that the level of safety afforded by the alarm device is maintained.

### Testing of Hazardous Condition Alarm Device

The manual testing of a hazardous condition alarm device allows the person carrying out the test to determine whether the detecting and warning functions of the alarm device are operating as intended. Therefore, regular testing of the hazardous condition alarm device by occupants is essential to ensure that the reliability of the alarm device is not compromised and that the level of safety afforded by the alarm device is maintained.

### False or Nuisance Alarm Silencing

It is well known that in many environments where hazardous condition alarm devices are installed the alarm devices are subjected to high rates of false or nuisance alarms as a result of non-hazardous activities generating products to which the alarm devices are responsive. A typical example of this problem is the response of smoke alarms installed in dwellings to smoke from burning toast, aerosols from cooking activities, steam and other non-threatening products present in domestic environments. A high incidence of false or nuisance alarms can discourage building occupants from using hazardous condition alarm devices to protect themselves, or for those who have been subjected to such incidents, the unsafe practice of disabling alarm devices by disconnecting them from their power supply sources is common and often results in occupants being left exposed and at risk.

Therefore, by silencing the warning provided by hazardous condition alarm devices for a short period of time during which occupants can intervene and clear the source of any false or nuisance alarm, the silencing function of hazardous condition alarm devices is an important feature for the effective management of false or nuisance alarms by occupants. Thus, the silencing facility of hazardous condition alarm devices has a positive impact on life safety of occupants as it reduces the likelihood of alarm devices being disabled, and that of prospective users of alarm devices refraining from using such devices for their protection, as a result of the high incidence of false or nuisance alarms.

### Low Battery Pre-Alarm Bypassing

An active low battery pre-alarm facility of a hazardous condition alarm device provides occupants with a warning of an impending low battery condition so that, if a battery is not immediately available when the low battery pre-alarm is emitted, the low battery pre-alarm facility can be bypassed to silence the warning. Thus, occupants receive prior warning, several hours or days in advance, of an impending low battery condition. During this time, occupants can procure themselves of a new battery to replace the one in use without having to resort to the unsafe practices of battery removal and disconnection/turning off of the power sources supplying the hazardous condition alarm device, or suffer the inconvenience of an ongoing audible warning being emitted.

### Access by Occupants for Carrying Out Operator Functions

Although the above mentioned operator functions are essential for the proper operation of hazardous condition alarm devices and/or are important to life safety, current alarm device designs incorporating operator function switches and batteries have the disadvantage that access to these switches and batteries can be difficult when the alarm devices are mounted on or near the ceiling as recommended by manufacturers to ensure fast alarm device response. This problem arises from the fact that for a large proportion of building occupants who are not tall, the height above the floor at which occupants can carry out the operator functions of hazardous condition alarm devices, mounted on or near the ceiling, is excessive resulting in the operator functions being inaccessible and inoperable by those occupants. In many cases, the problem of the lack of access for carrying out operator functions results in building occupants becoming frustrated and simply disabling alarm devices by disconnecting them from their power supply sources leaving them exposed and at risk. In other cases, building occupants resort to climbing on items of furniture, as a proper ladder is not always available, to operate operator function switches or replace batteries of hazardous condition alarm devices and they do so at considerable risk of injury to themselves.

The problems associated with difficult access to operator function switches and batteries of hazardous condition alarm devices installed on or near the ceiling are made worse if the building occupant is a person with a disability, for example somebody who is wheelchair bound, or if the occupant is an elderly person, is frail, or is under the influence of alcohol, drugs or medication when balance may be a problem.

It is to be noted that, in recognition of the above described accessibility problems associated with operator function switches and batteries of hazardous condition alarm devices, some manufacturers offer solutions that, whilst solving the accessibility problems previously identified, the solutions are themselves problematic and disadvantageous in many ways. These solutions are as follows:
A type of hazardous condition alarm device, namely a smoke alarm marketed under the brand name of FireAngel, is designed for installation into a light socket of a normal mains powered switched electrical light circuit. The hazardous condition alarm device is designed in such a way that regular alarm device testing is carried out by turning power on and off to the alarm device once by operating the switch controlling the light circuit.

Similarly, turning power on and off to the hazardous condition alarm device twice activates the silencing facility of the alarm device. The FireAngel design also incorporates a rechargeable standby power source which is kept charged whenever mains power to the smoke alarm is switched on.

Although the FireAngel design provides access to the silencing and manual testing operator functions of the smoke alarm, the design is problematic as it allows the operator silencing and testing functions to be performed only when mains electricity supply is available. Furthermore, for safety reasons many codes and standards around the world do not allow smoke alarms to be installed on switched electrical circuits as it is possible for these circuits to remain de-energised for very long periods. The disadvantage with the FireAngel design is that during these long periods when the electrical circuit is de-energised the backup power source may completely be depleted to result in the smoke alarm becoming inoperative.

Another disadvantage of the FireAngel smoke alarm design is that, when installed in a light socket, the smoke alarm and the light bulb are co-located. This arrangement is not in accordance with most installation standards and manufacturer's recommendations that require smoke alarms to be kept away from light fittings as the heat released by light bulbs can interfere with the movement of smoke and the performance of the smoke alarm. A further disadvantage of the FireAngel design is that the smoke alarms must always be operated from mains supply and low cost single supply battery operated smoke alarms of this design are not possible.
Some manufacturers of hazardous condition alarm devices offer remote alarm device testing and silencing switches that are connected to the alarm devices by electrical wiring. Thus, these switches can be mounted at a convenient height on a wall and the alarm device testing and silencing operator functions can then be carried out from the installed switch locations.

The disadvantage of remote mounted operator function switches of hazardous condition alarm devices is that it is not always possible to install wiring to wall mounted switches in existing buildings due to access problems. Even where it is possible to install wiring in walls of existing buildings, and in new buildings, wiring to wall mounted remote operator function switches is more often than not a specialised task requiring the services of a wiring specialist. Therefore, the installation of the remote wall mounted operator function switches is disadvantageous in that it is often expensive to carry out.

A further disadvantage of remotely wired operator function switches is that the hazardous condition alarm devices are no longer self-contained which, in at least the case of single supply battery operated hazardous condition alarm devices, would discourage installation by the vast majority of potential users of such alarm devices who are do-it-yourself type installers.
The remote control of the operator functions of hazardous condition alarm devices is now being offered by some manufacturers so as to overcome the accessibility problems associated with the testing and silencing of alarm devices by building occupants. Thus, one manufacturer offers smoke alarms incorporating a photoelectric cell, and a light from a torch directed at the photoelectric cell is used as a signal for initiating alarm device testing/In smoke alarms of another brand, the alarm devices include infrared receiver circuits that are activated by a hand held infrared transmitter to remotely silence and test the alarm devices.

A disadvantage of remote control operator functions of hazardous condition alarm devices is that reliance is placed on an additional piece of powered equipment, the torch or the infrared transmitter, for carrying out the important functions of alarm device silencing and testing, equipment that may not be available when required if it is misplaced or lost. Another disadvantage of remote control operator functions of hazardous condition alarm devices is that the required torch or infrared transmitter is powered by batteries whose condition are not normally monitored, and therefore there is a real risk that the torch or transmitter fails to operate when required due to flat or missing batteries. A further disadvantage of the remote control operator functions of hazardous condition alarm devices is that, in a building where a number of alarm devices may be installed, generally only one torch or infrared transmitter will be available. With such an arrangement, and in the event of a false or nuisance alarm that requires the silencing of one particular alarm device, the torch or transmitter may be quite remote from the alarm device to be silenced and therefore inconvenient long delays before silencing are possible.

### SUMMARY OF INVENTION

This invention, in one aspect, resides broadly in a method of facilitating access by an operator for the purpose of carrying out one or more operator functions of a hazardous condition alarm device mounted on or near the ceiling, said operator functions consisting of operating an alarm device test switch, operating an alarm device silence switch, operating an alarm device low battery pre-alarm active/bypass switch, or replacing an alarm device battery, the method including:
lowering the height above the floor at which the operator functions of the hazardous

condition alarm device can be carried out.

It will be appreciated that, for various reasons, any one hazardous condition alarm device of this invention may not have all the above mentioned operator functions. Some of these reasons are listed below.
Although the hazardous condition alarm device test function is usually found in all alarm devices as it is a compulsory requirement of many relevant codes and standards, the other operator functions associated with alarm device silencing and the low battery pre-alarm activation and bypassing, although very useful, are optional functions that may or may not be provided in hazardous condition alarm devices of this invention.
Some hazardous condition alarm devices of this invention may have long-life batteries that are designed to last the full life of the alarm device and therefore battery replacement by the operator is not necessary.
Some hazardous condition alarm devices of this invention may form part of a central hazardous condition alarm system in which the battery power supply is common to all the system's alarm devices. In such cases, the system's alarm devices do not usually have batteries as these would normally be located remotely as part of the system's central control panel/box. Therefore, battery replacement is usually not a required operator function of alarm devices forming part of a hazardous condition alarm system incorporating hazardous condition alarm devices of this invention.
Some single supply hazardous condition alarm devices of this invention may not require batteries for their operation. An example of such an alarm device is one that does not have a battery backup supply and operates from mains power supply only. Therefore, battery replacement is not a required operator function of these single supply alarm devices of this invention.

The lowering of the height above the floor at which the operator functions of hazardous condition alarm devices of this invention can be carried out can be effected by various means to achieve the desired result. In one preferred embodiment of the invention, the hazardous condition alarm device incorporates several operator function switches including an alarm device test switch, an alarm device silence switch, and an alarm device low battery pre-alarm active/bypass switch, and the height above the floor at which the operator function switches are located and operable is lowered by using operator function switches that are pull cord operated.

In another preferred embodiment of the invention, the hazardous condition alarm device incorporates a battery and several operator function switches including an alarm device test switch, an alarm device silence switch, and an alarm device low battery pre-alarm active/bypass switch, and the height above the floor at which the operator function switches are located and operable and that at which the battery can be accessed is lowered by:
extending the hazardous condition alarm device such that, when the alarm device is

mounted on or near the ceiling, the extension is towards the floor, and
locating the operator function switches and the battery of the hazardous condition alarm device in the extended section of the hazardous condition alarm device to reduce the height above the floor at which the battery can be accessed and that at which the operator function switches are located and operable.

It must be realised that the extension of the hazardous condition alarm device can take various forms. Thus, the extension can be an integral part of the hazardous condition alarm device, or the extension can be a separate base or plate cooperatively mounted with the hazardous condition alarm device to allow wiring and connections to any one or more operator function switches and/or alarm device battery located in the extension. In the latter case, once the hazardous condition alarm device and the base or plate are cooperatively mounted in a final installed position, the alarm device and the base or plate become indistinguishable and the hazardous condition alarm device is to be taken to be the complete installed extended assembly.

In another aspect the invention resides broadly in a hazardous condition alarm device

including:

(a) any one or more of the following:
a battery;
an alarm device test switch;
an alarm device silence switch;
an alarm device active/bypass, and
   (b) height lowering means for lowering the height above the floor at which the battery can be accessed and that at which the operator function switches are located and operable, and wherein:
   (c) said height lowering means includes:
(i) means for extending said hazardous condition alarm device such that, when the alarm device is mounted on or near the ceiling, the extension is towards the floor, and
(ii) means for locating the battery and the operator function switches of the hazardous condition alarm device in the extension of the alarm device to reduce the height above the floor at which the battery can be accessed and that at which the operator function switches are located and operable.

In another aspect the invention resides broadly in a hazardous condition alarm device that is suitable for mounting on or near the ceiling and including any one or more operator function switches such as an alarm device test switch, an alarm device silence switch, an alarm device active/bypass, and wherein the operator function switches are pull cord operated.

### BRIEF DESCRIPTION OF DRAWINGS

FIG. 1 is a schematic of a room illustrating alarm installation requirements.

FIG. 2 is a schematic illustrating an alarm installation from the side.

FIG. 3 is a schematic illustrating the alarm installation of FIG. 2 from the front.

FIG. 4 is another schematic illustrating the alarm installation of FIG. 2 from the front.

FIG. 5 is a side-view schematic illustrating another alarm installation.

FIG. 6 is a front-view schematic illustrating the alarm installation of FIG. 5.

FIG. 7 is a front-view schematic illustrating another alarm installation.

FIG. 8 is a side-view schematic illustrating the alarm installation of FIG. 7.

FIG. 9 is a front-view schematic illustrating the alarm installation of FIG. 7.

FIG. 10 is a front-view schematic illustrating another alarm installation.

FIG. 11 is a side-view schematic illustrating the alarm installation of FIG. 10.

FIG. 12 is a rear-view schematic illustrating the alarm installation of FIG. 10.

FIG. 13 is a schematic illustrating two alarm installations.

### PREFERRED EMBODIMENTS OF THE INVENTION

The method and the hazardous condition alarm devices of this invention are best explained by referring to the following preferred embodiments. However, the preferred embodiments described in the following subsections of this specification, and illustrated by the accompanying drawings, are merely illustrative of how the invention might be put into effect and are not to be understood to be limiting on the invention. For example, all preferred embodiments described relate to hazardous condition alarm devices that are single supply battery operated smoke alarms although the method of this invention applies equally to dual supply smoke alarms and to other hazardous condition alarm devices sensing hazardous products other than smoke. Furthermore, although the preferred embodiments may require several operator functions to be carried out, it is to be understood that other practical examples of hazardous condition alarm devices of this invention may only require one or only some, but not all, of the operator functions to be carried out.

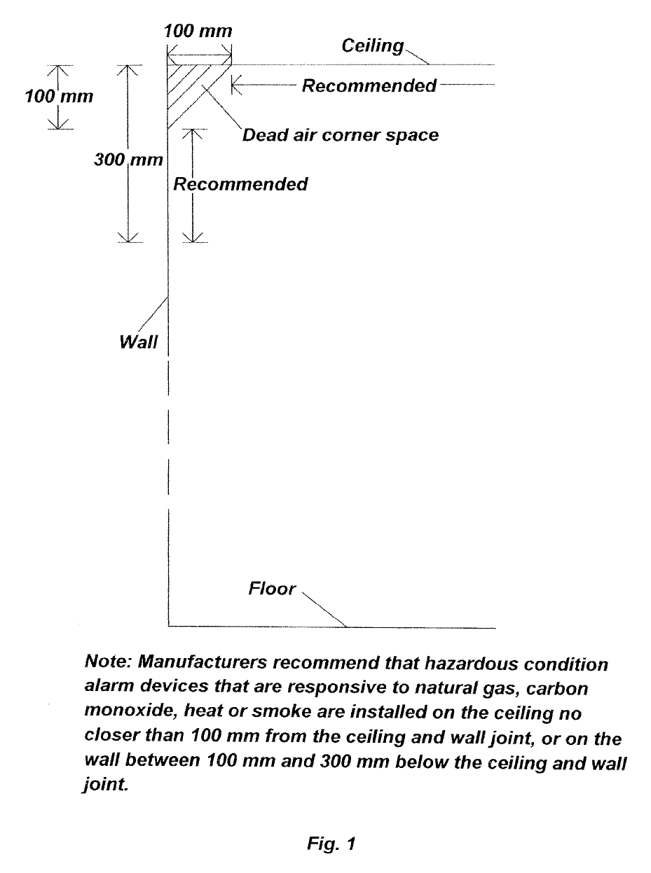

FIG. 1 is a typical section of a protected room showing the ceiling to wall dead air corner space extending 100 mm vertically and horizontally from the ceiling and wall joint, and in which manufacturers recommend that hazardous condition alarm devices not be installed. FIG. 1 also identifies areas along the ceiling and wall where manufacturers recommend that hazardous condition alarm devices be installed to ensure the best possible alarm device response when a hazardous condition exists.

### First Preferred Embodiment

The first preferred embodiment overcomes the accessibility problems associated with the operation of hazardous condition alarm device operator function switches by persons with a permanent disability, such as those who are wheelchair bound. However, the difficulties overcome by the first preferred embodiment of this invention would equally benefit other persons who are not tall, the elderly and those who are frail or are under the influence of alcohol, drugs or medication when balance may be a problem. A height at which such persons can operate the operator function switches is referred to herein as “height for operator accessibility”.

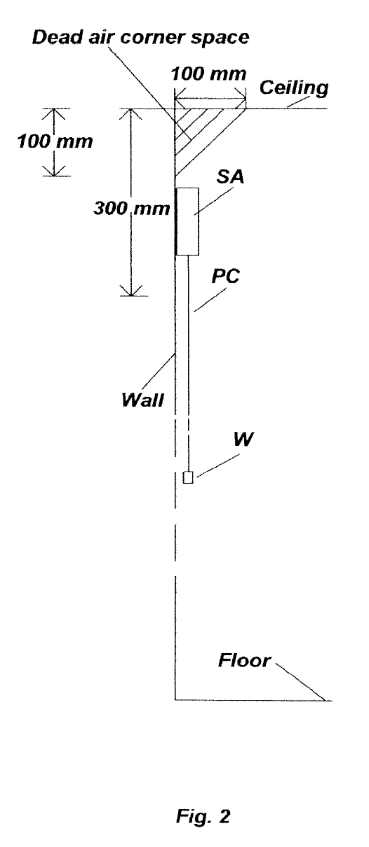

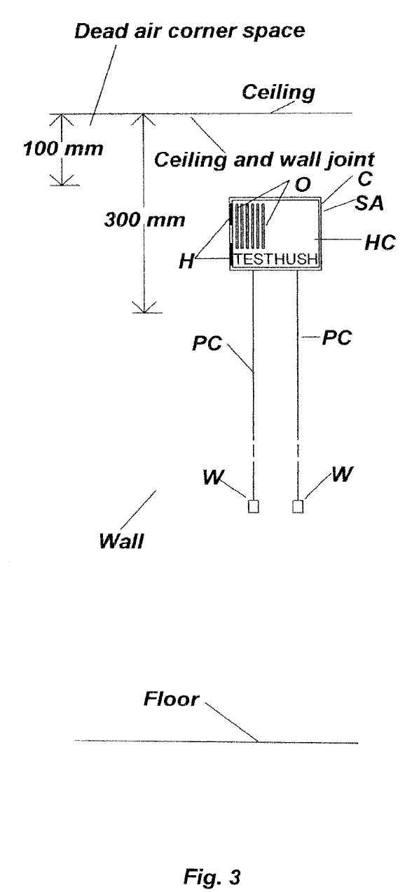

The first preferred embodiment is as depicted by FIG. 2 and FIG. 3 which provide a side view and a front view respectively of a single supply battery operated smoke alarm SA mounted within the recommended portion of the wall extending from 100 mm to 300 mm below the ceiling and wall joint. The smoke alarm SA incorporates an alarm device test switch and an alarm device silence/hush switch that are operable using the pull cord PC of each of the alarm device operator function switches. Each pull cord PC has a small weight W at its end to ensure that each pull cord hangs taught for improved visual appearance. Referring to FIG. 3, it can be seen that the smoke alarm SA has a front hinged cover HC having openings 0 to allow air and smoke to reach the sensor of the smoke alarm mounted on the printed circuit board of the alarm device. The hinged cover HC of the smoke alarm SA is connected to the smoke alarm casing C through hinges H. The hinged cover HC and smoke alarm casing C together form a single integrated housing of the smoke alarm.

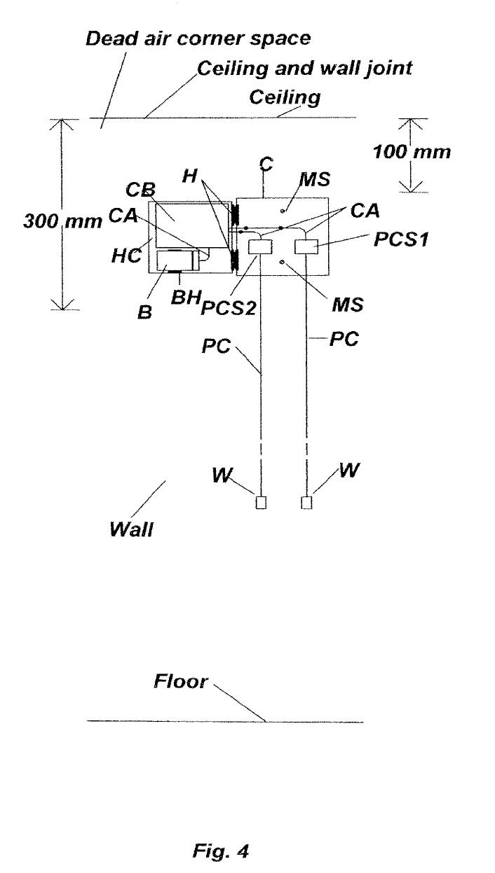

Further construction details of the smoke alarm SA of the first preferred embodiment are as per FIG. 4 which provides a front view of the smoke alarm with the front hinged cover HC in open position. Thus, it can be seen that in the first preferred embodiment the smoke alarm printed circuit board CB and the smoke alarm battery R, held in battery holder BH, are mounted on the inner face of the hinged cover HC connected to the smoke alarm casing C by hinges H.

The smoke alarm casing C is fixed to the wall by mounting screws MS and contains pull cord switches PCS1 and PCS2 for silencing and testing the smoke alarm respectively. Pull cord switches PCS1 and PCS2 are connected to pull cords PC and weights W in the usual way, the pull cords PC hanging down below the smoke alarm casing C through openings in the lower part of the casing C. FIG. 4 also shows cables CA for electrically connecting the pull cord switches PCS1 and PCS2 and battery B to the smoke alarm printed circuit board CB.

Since the pull cords PC of the smoke alarm SA depicted by FIG. 2, FIG. 3 and FIG. 4 extend below the wall mounted smoke alarm SA, the pull required on the pull cords to operate the smoke alarm test and silence/hush switches can be applied at a height above the floor that is less than that above the floor at which the smoke alarm SA is mounted. Thus, the provision of pull cord operated smoke alarm test and silence/hush switches lowers the height above the floor at which these operator function switches of the smoke alarm SA are located and operable.

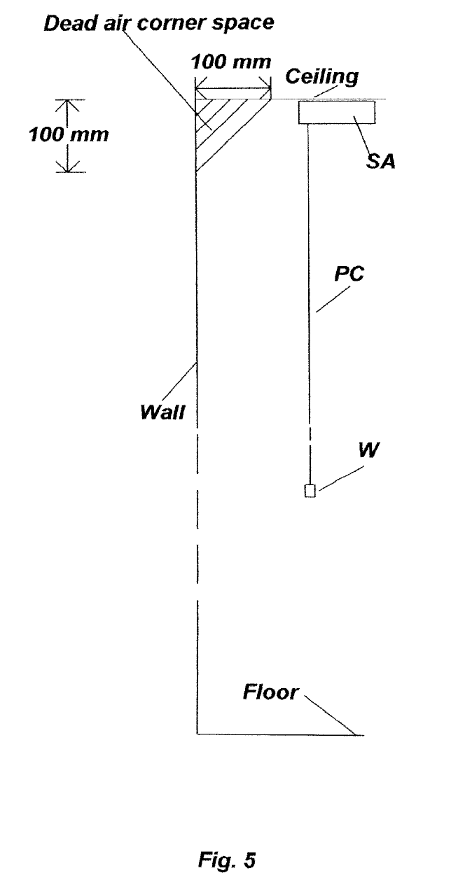

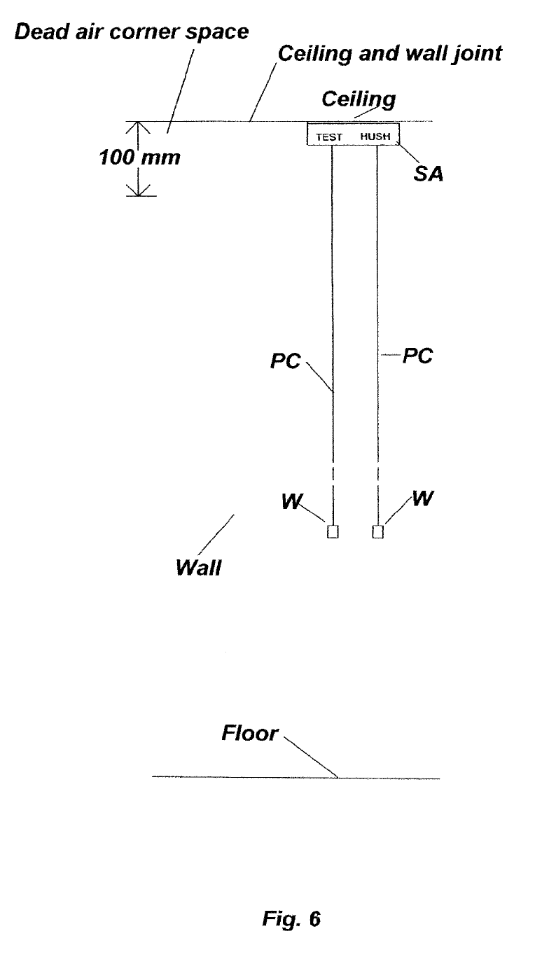

A variation of the first preferred embodiment of this invention is as shown in FIG. 5 and FIG. 6 which are side and front views respectively of a ceiling mounted smoke alarm SA incorporating pull cords PC and weights W associated with the smoke alarm test and silence/hush switches. FIG. 5 and FIG. 6 show the smoke alarm SA installed on the ceiling in a location that is more than 100 mm from the ceiling wall joint as recommended by manufacturers. The testing and silencing operator functions of the ceiling mounted smoke alarm SA are carried out in a manner identical to that previously described for the first preferred embodiment.

### Second Preferred Embodiment

The second preferred embodiment overcomes the accessibility problems associated with the operation of hazardous condition alarm device operator function switches and battery replacement by persons who are not tall, the elderly and those who are frail or are under the influence of alcohol, drugs or medication when balance may be a problem.

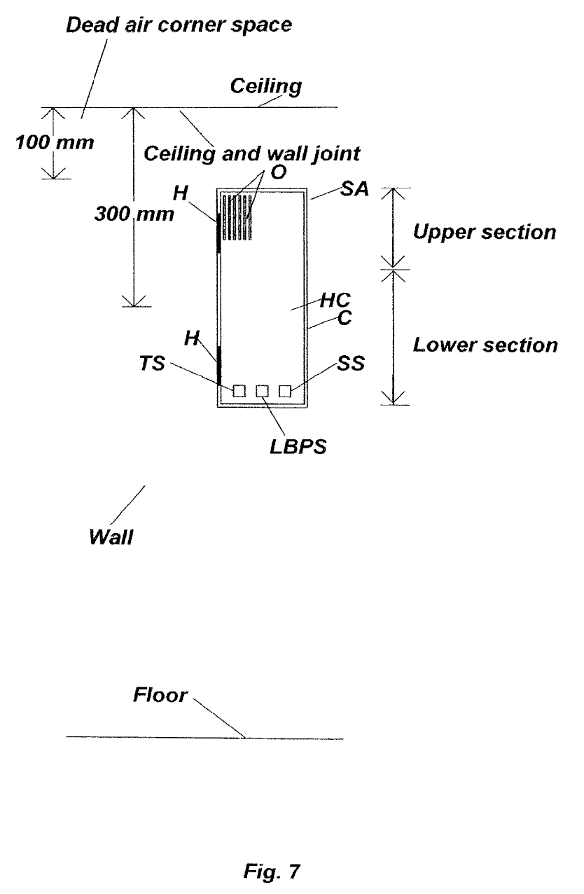

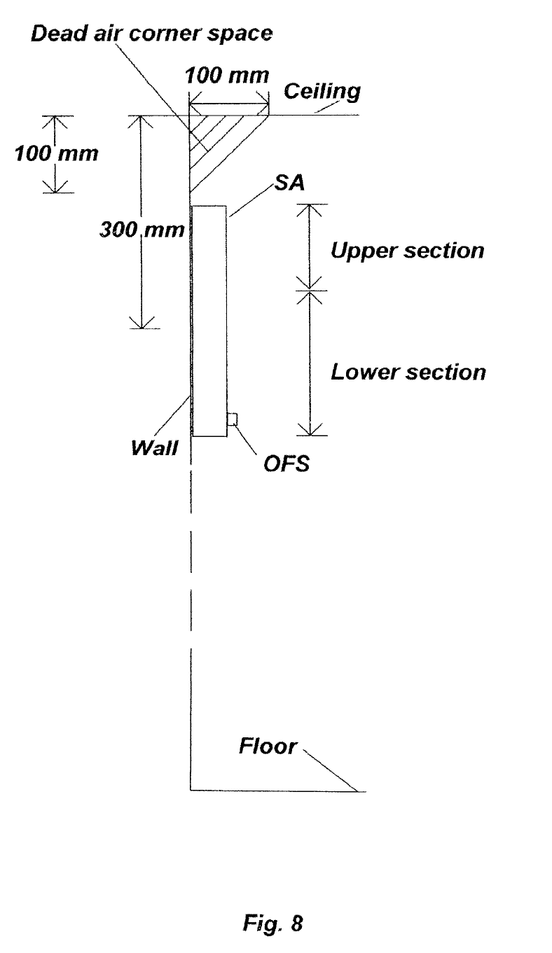

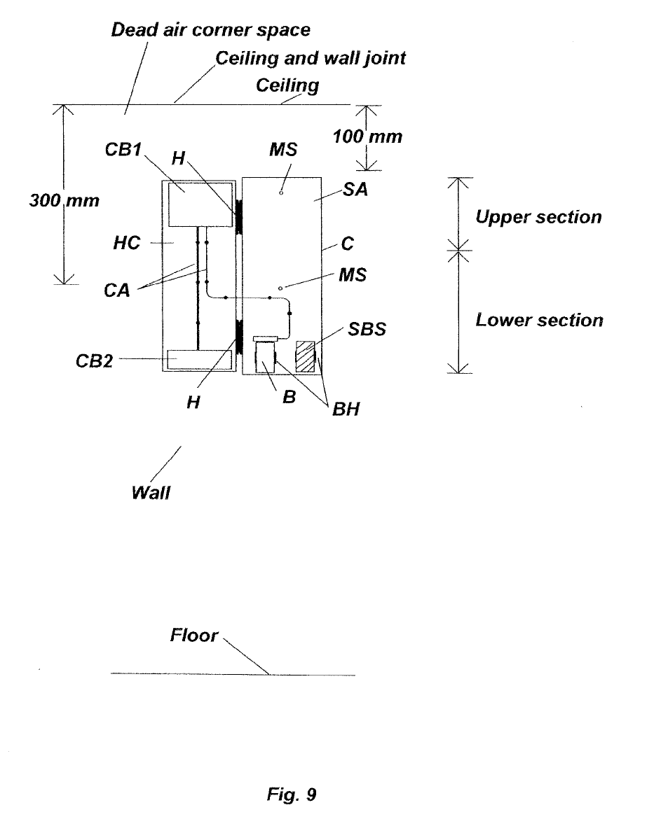

The second preferred embodiment is as depicted by FIG. 7, FIG. 8 and FIG. 9 which provide a front view, a side view and a second front view with hinged cover open respectively of a hazardous condition alarm device that is a single supply battery operated smoke alarm. According to FIG. 7, the smoke alarm SA is mounted on the recommended portion of the wall extending from 100 mm to 300 mm below the ceiling and wall joint. The smoke alarm SA incorporates an alarm device test switch TS, an alarm device silence/hush switch SS and a low battery pre-alarm active/bypass switch LBPS that are all grouped in the lower section of the front hinged cover HC of the smoke alarm SA. The upper section of smoke alarm SA includes openings 0 to allow air and smoke to reach the sensor of the smoke alarm SA mounted on the printed circuit board of the alarm device. The hinged cover HC of the smoke alarm SA is connected to the smoke alarm casing C through hinges H. The hinged cover HC and smoke alarm casing C together form a single integrated housing of the smoke alarm.

FIG. 8 provides a side view of the smoke alarm SA mounted on the wall so that the smoke sensor of the alarm device, located within the upper section of the smoke alarm SA, is mounted on the portion of the wall extending from 100 mm to 300 mm below the ceiling and wall joint as recommended by manufacturers. FIG. 8 also shows the operator function switches OFS protruding through the lower section of smoke alarm SA.

Further construction details of the smoke alarm SA of the second preferred embodiment are as per FIG. 9 which provides a front view of the smoke alarm SA with the front hinged cover HC in open position. Thus, it can be seen that in the second preferred embodiment of the invention the smoke alarm main printed circuit board CB1 incorporating the smoke alarm sensor and the operator function switches printed circuit board CB2 are mounted on the upper and lower sections respectively of the inner face of the hinged cover HC connected to the smoke alarm casing C by hinges H. FIG. 9 also shows the smoke alarm battery B and battery holders BH for holding the smoke alarm battery B and a spare battery, when available and located in spare battery space SBS, all contained within the lower section of the smoke alarm casing C. The arrangement of FIG. 9 shows the casing C of the smoke alarm SA fixed to the wall by mounting screws MS and cables CA for electrically connecting the operator function switches printed circuit board CB2 and the smoke alarm battery B to the smoke alarm main printed circuit board CB1.

It can be seen from the previous description of FIG. 7 through to FIG. 9 that the lower section of the smoke alarm SA of the second preferred embodiment is in fact an extension of the smoke alarm so that, when the smoke alarm SA is in its installed position on the wall, the extension is towards the floor. Thus, locating the operator function switches within the lower extended portion of the smoke alarm SA ensures that the height above the floor at which the switches are located and operable is lowered. Similarly, locating the smoke alarm battery B and the spare battery, when available, in the accessible part of the lower extended portion of the smoke alarm SA reduces the height above the floor at which the batteries can be accessed when battery replacement is required.

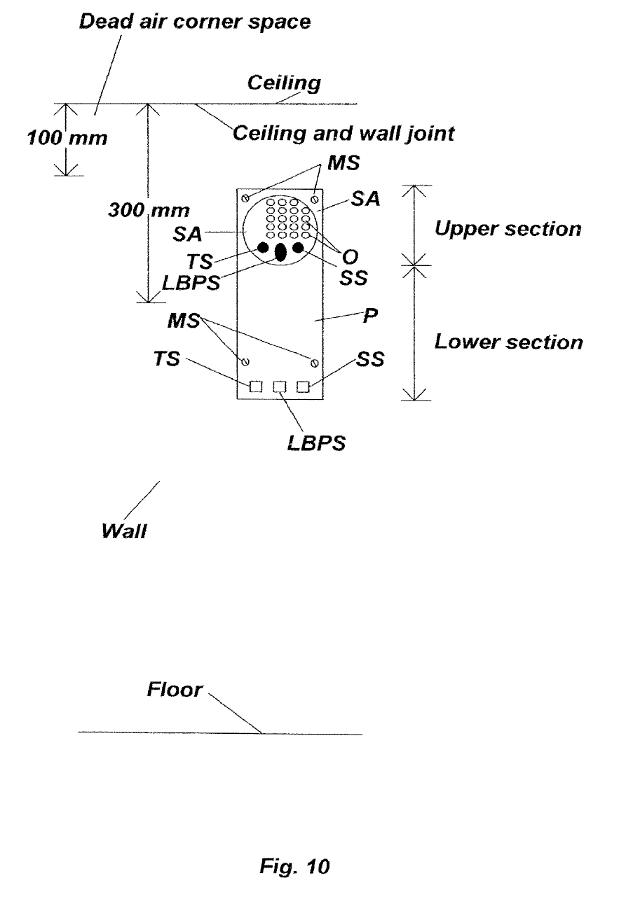

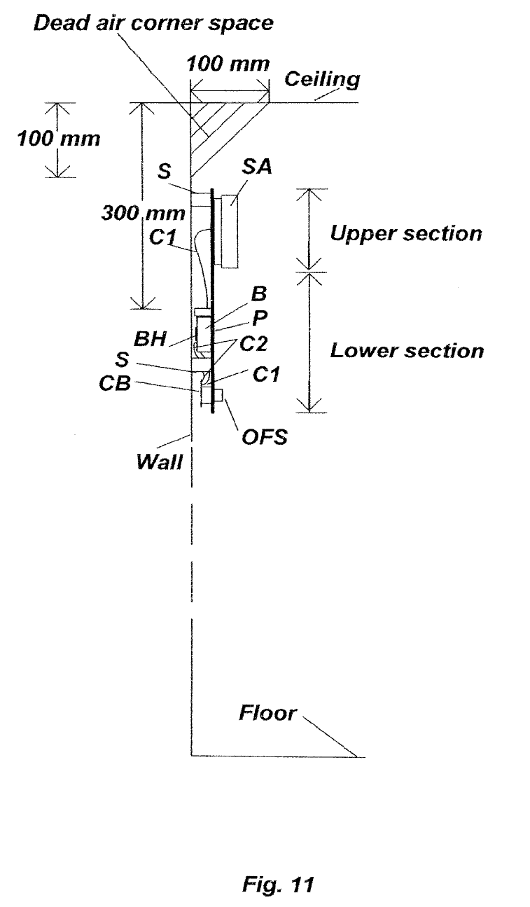

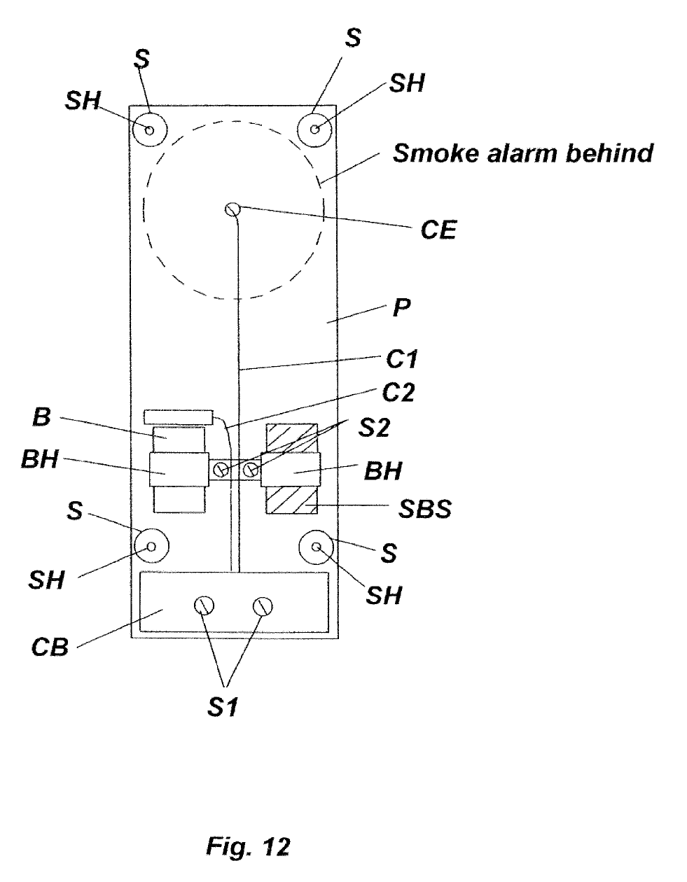

A variation of the second preferred embodiment of this invention is as shown in FIG. 10, FIG. 11 and FIG. 12 which are front, side and rear views respectively of a smoke alarm assembly mounted on the wall. FIG. 10 shows a smoke alarm assembly comprising of a plate P, a conventional smoke alarm SA incorporating air/smoke sampling openings 0, a smoke alarm test switch TS, a low battery pre-alarm active/bypass switch LBPS and a smoke alarm silence/hush switch SS. The conventional smoke alarm SA is located on the upper section of the plate P so that when the smoke alarm assembly is in its final installed position on the wall, the smoke alarm is located on the recommended portion of the wall extending from 100 mm to 300 mm below the ceiling and wall joint. A second set of operator function switches to include a smoke alarm test switch TS, a low battery pre-alarm active/bypass switch LBPS and a smoke alarm silence/hush switch SS is located in the lower section of the plate P so that the switches protrude through the plate P. FIG. 10 also shows mounting screws MS that are used to mount the smoke alarm assembly on the wall.

FIG. 11 shows a side view of the variation of the second preferred embodiment of this invention wherein the plate P of the smoke alarm assembly is spaced from the wall, when installed, using spacers S. According to FIG. 11, the space between the plate P and the wall is used to accommodate a printed circuit board CB on which the operator function switches OFS are mounted. The smoke alarm battery B is held in place by a battery holder BH and cables C1 and C2, also located in the space between the plate P of the smoke alarm assembly and the wall, are used to electrically connect the smoke alarm SA and the smoke alarm battery B to the operator function switches printed circuit board CB. The smoke alarm battery B and the spare battery, if available, can both be accessed by an operator through the open sides of the space between plate P of the smoke alarm assembly and the wall.

FIG. 12 is a rear view of the smoke alarm assembly showing the four sets of screw holes SH and spacers S used for mounting and spacing the plate P from the wall. FIG. 12 shows the outline of the smoke alarm SA on the front upper section of the face of plate P, cable entry CE to allow electrical connection of the smoke alarm SA to the operator function switches printed circuit board CB, located in the lower section of the smoke alarm plate P, via cable Cl. FIG. 12 also shows the smoke alarm battery B held in position by a battery holder BH which also has provision for holding a spare battery, if available, in the spare battery space SBS. Cable C2 is used to electrically connect the smoke alarm battery B to the operator function switches printed circuit board CB which, together with battery holder BH, are fixed to the plate P of the smoke alarm assembly by screw sets S1 and S2 respectively.

It can be seen from the previous description of FIG. 10 through to FIG. 12 that the lower section of the smoke alarm SA of the variation of the second preferred embodiment is in fact an extension of the smoke alarm SA so that, when the smoke alarm assembly is in its installed position, it serves as an extension of the smoke alarm SA towards the floor. As an installed assembly, the plate P and the conventional smoke alarm SA together form a single integrated housing of the smoke alarm. Thus, locating the operator function switches within the lower extended portion of smoke alarm assembly ensures that the height above the floor at which the switches are located and operable is lowered. Similarly, locating the smoke alarm battery B and the spare battery, when available, in the accessible part of the lower extended portion of smoke alarm assembly reduces the height above the floor at which the batteries can be accessed.

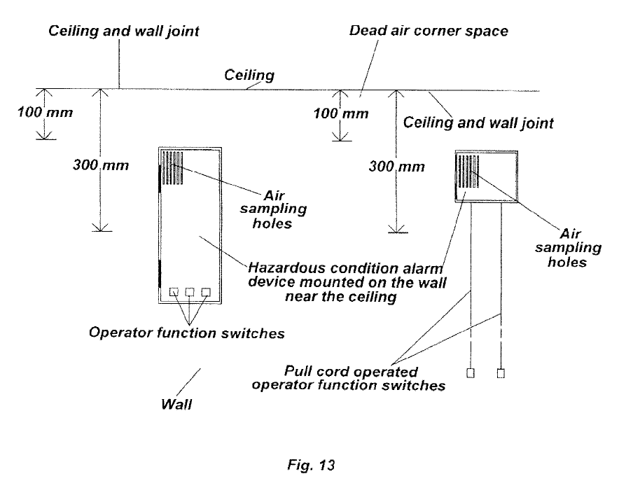

FIG. 13 is a schematic illustrating two different types of alarm installations.

1. (canceled)

2. (canceled)

3. (canceled)

4. (canceled)

5. (canceled)

6. (canceled)

7. (canceled)

8. (canceled)

9. (canceled)

10. A hazardous condition alarm device comprising:
a single integrated housing;
the housing containing a hazard sensor for detecting a hazardous condition and one or more operator function switches, the housing configured for mounting with the sensor on or near a ceiling;
pull cord extending from the at least one of the operator function switches with an end extending exterior to the housing to a height for operator accessibility.

11. The device of claim 10 wherein the housing comprises an alarm device casing and a hinged cover attached to the casing by hinges.

12. The device of claim 10 wherein the housing comprises a mounting plate cooperatively mounted with a conventional type hazardous condition alarm device.

13. The device of claim 10 wherein the operator function switches include at least one of alarm device test switch, alarm device silence switch, alarm device low battery pre-alarm active/bypass switch.

14. A hazardous condition alarm device comprising:
a single integrated housing:
an upper section within the housing containing a hazard sensor for detecting a hazardous condition;
a lower section within the housing containing one or more operator function switches;
the housing configured and dimensioned for mounting on a wall with the sensor in the upper section near a ceiling and with the lower section in a lower extension of the housing such that the operator function switches can be operated at a height for operator accessibility.

15. The device of claim 14 wherein the house comprises a smoke alarm casing and a hinged cover attached to the casing by hinges.

16. The device of claim 14 wherein an alarm battery is located in the lower section such that the alarm battery is at a predetermined height for accessibility.

17. The device of claim 14 wherein the operator switches include at least one of alarm device test switch, alarm device silence switch, alarm device low battery pre-alarm active/bypass switch.

18. The device of claim 14 wherein the housing comprises a mounting plate cooperatively mounted with a conventional type hazardous condition alarm device.
